(19) United States
(12) Patent Application Publication
(10) Pub. No.: US 2017/0171304 A1
(43) Pub. Date: Jun. 15, 2017

(54) SERVICE UPDATING METHOD AND SYSTEM FOR SERVER CLUSTER

(71) Applicants: LE HOLDINGS (BEIJING) CO., LTD., Beijing (CN); LECLOUD COMPUTING CO., LTD, Beijing (CN)

(72) Inventor: Qinghua NIU, Beijing (CN)

(21) Appl. No.: 15/246,154

(22) Filed: Aug. 24, 2016

Related U.S. Application Data
(63) Continuation of application No. PCT/CN2016/088855, filed on Jul. 6, 2016.

(30) Foreign Application Priority Data
Dec. 9, 2015 (CN) 201510903213.X

(51) Int. Cl. H04L 29/08; H04L 12/26

(52) U.S. Cl. CPC H04L 67/1025; H04L 43/16; H04L 67/36

(57) ABSTRACT

The disclosure provides a service updating method for a server cluster, wherein the server cluster has a plurality of original servers, and the method includes: performing local updating: using new servers to substitute part of the original servers to receive access requests; performing performance testing: comparing a performance representation value of the new servers with a preset threshold value; canceling the local updating if the performance representation value is lower than the preset threshold value, debugging the new servers, re-performing the debugged server with the local updating and performance testing till the performance representation value is higher than the preset threshold value; and continuing to perform the local updating and the performance testing if the performance representation value is higher than the preset threshold value till the new servers substitute all the original servers to receive the access requests, thus finishing the service updating of the server cluster. The embodiments of the disclosure further provide a service updating system for a server cluster, gray scale updating of the service of the server cluster is realized, and the launching speed of a new service is quickened.

### CROSS REFERENCE TO RELATED APPLICATIONS

This application is a continuation of International Application No. PCT/CN2016/088855, filed on Jul. 6, 2016, which is based upon and claims priority to Chinese Patent Application No. 201510903213.X, filed on Dec. 9, 2015, the entire contents of both of which are incorporated herein by reference.

### TECHNICAL FIELD

The present disclosure relates to the technical field of service updating, and in particular to a service updating method and system for a server cluster.

### BACKGROUND

Along with prosperous development of mobile Internet, application software has become a necessity of daily life of Internet users. Large-scale websites have numerous users and consumer groups, and how to optimize an access request to enhance the user experience is an urgent and difficult problem for many large-scale Internet companies.

### SUMMARY

Embodiments of the present disclosure provide a service updating method, system and non-transitory computer-readable medium for a server cluster.

The present disclosure provides a service updating method of a server cluster including a plurality of original servers. The method may include: performing local updating: using new servers to substitute part of the original servers to receive access requests; and performing performance testing: comparing a performance representation value of the new servers with a preset threshold value, canceling the local updating if the performance representation value is lower than the preset threshold value, debugging the new servers, re-performing the debugged server with the local updating and performance testing till the performance representation value is higher than the preset threshold value, and continuing to perform the local updating and the performance testing if the performance representation value is higher than the preset threshold value till the new servers substitute all original servers to receive the access requests, thus finishing the service updating of the server cluster.

The present disclosure provides a service updating system for a server cluster having a plurality of original servers. The system may include new servers and a performance tester interacting with the new servers, wherein the new servers may be configured to perform local updating by substituting part of the original servers to receive access requests and execute a corresponding operation based on a signal sent from the performance tester; and the performance tester may be configured to compare a performance representation value of the new servers with a preset threshold value, send a local updating canceling signal to the new servers if the performance representation value is lower than the preset threshold value, and send a local updating continuing signal to the new servers if the performance representation value is higher than the preset threshold value.

The present disclosure further provides a non-transitory computer-readable storage medium storing executable instructions for updating a service for a server cluster including a plurality of original servers, wherein the executable instructions, when executed by a processor, cause the processor to: perform local updating by: using new servers to substitute part of the original servers to receive access requests; and perform performance testing by: comparing a performance representation value of the new servers with a preset threshold value; canceling the local updating if the performance representation value is lower than the preset threshold value, debugging the new servers, and re-performing the debugged server with the local updating and performance testing till the performance representation value is higher than the preset threshold value, and continuing to perform the local updating and the performance testing if the performance representation value is higher than the preset threshold value till the new servers substitute all the original servers to receive the access requests, thus finishing the service updating of the server cluster.

It should be understood that both the foregoing general description and the following detailed description are exemplary and explanatory only and are not restrictive of the disclosure

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the embodiments of the present disclosure, figures to be used in the embodiments will be briefly introduced in the following. Apparently, figures in the following description are some embodiments of the present disclosure, and other figures can be obtained by those skilled in the art based on these figures without inventive efforts.

FIG. 1 shows a flow drawing of a service updating method for a server cluster of an embodiment of the present disclosure;

FIG. 2 shows a schematic structural drawing of a service updating system for a server cluster of an embodiment of the present disclosure;

FIG. 3 shows a schematic drawing in which part of servers in a server cluster are updated according to an embodiment the present disclosure; and

FIG. 4 is a schematic structural drawing of an electronic device of an embodiment of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The inventor finds in the process of implementing the present disclosure that regarding the problem, a common solution of many network operators is to update the services of a server cluster continuously. Common service updating methods of server clusters may be divided into three types as follows.

1. A server of the server cluster is paused within a period of a small visit volume, the access request of a user to the server is not accepted, and the services of the server are recovered after the server is updated. Therefore, although the services of the server cluster are updated, a user cannot access the server of the server cluster within the updating period of the server, and the user experience of a server operator is severely affected.

2. A server of the server cluster is paused within a period of a small visit volume, the access request of the user to the server is not accepted, and the access request is forwarded to other servers in the server cluster. By using this method for updating, although the experience of the user on the original service is not affected within the updating period, the user cannot experience a new service in time that the updated server provides, and the experience of the user on the new service is affected.

3. The user access to one server is switched to another server that is working in the server cluster. For large-scale network companies, the user visit volume borne by each server is massive. Therefore, such a method will severely increase the burden of the second server, a large updating risk still exists, and when the quantity of the servers to be updated is numerous, the operation is much too troublesome to implement.

Embodiments of the present disclosure provide a service updating method, a system a non-transitory computer-readable medium for a server cluster, aiming at solving at least one technical problem, realizing the updating of the server cluster in a gray scale manner and accelerating the launching speed of a new service.

By using the service updating method, system and non-transitory computer readable medium for a server cluster provided by the embodiments of the present disclosure, the new servers equipped with new services are added to the server cluster, and substitute the original servers in the server cluster to receive the access requests, such that the server cluster can process the access requests of the user even in a service updating process.

In addition, in the service updating process of the server cluster, the user can experience the new service, and the launching speed of the new service is quickened.

Further, the server cluster with the new services is tested online. When encountering a problem, the new servers can be debugged in time, such that the normal and effective operation of the new servers is guaranteed. Further, when the new servers are debugged, the working state of the original servers is recovered, such that the situation that the access requests cannot be processed caused by a fault of the new servers in the service updating process of the server cluster is avoided.

The access requests sent to the original servers in the server cluster are indirectly forwarded to the new servers. Compared with a manner that the access requests received by the original servers in a substituting state are forwarded to other original servers, the work load of other substituting servers in the service updating process of the server cluster is reduced, and the work of scheduling the access requests is also simplified.

The new servers gradually substitute the original servers in the server cluster to receive the access requests received by the original servers, such that the risk generated by a fact that the new servers directly substitute all the original servers in the server cluster to receive the access requests received by the original servers is reduced.

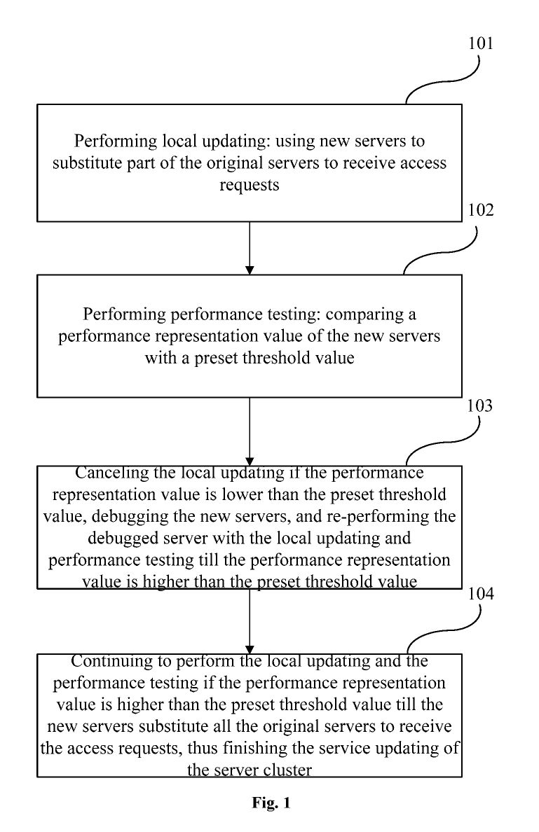

FIG. 1 is a flow drawing of a service updating method for a server cluster of an embodiment of the present disclosure, the server cluster includes a plurality of original servers, and the method includes:

S101: performing local updating: using by a service updating apparatus new servers to substitute part of the original servers to receive access requests;

S102: performing performance testing: comparing by the service updating apparatus a performance representation value of the new servers with a preset threshold value;

S103: canceling by the service updating apparatus the local updating if the performance representation value is lower than the preset threshold value, debugging the new servers, and re-performing the debugged server with the local updating and performance testing till the performance representation value is higher than the preset threshold value; and

S104: continuing to perform by the service updating apparatus the local updating and the performance testing if the performance representation value is higher than the preset threshold value till the new servers substitute all original servers to receive the access requests, thus finishing the service updating of the server cluster.

The service updating apparatus in the present embodiment is a server or server cluster, or current new servers or current original servers.

The service updating method for a server cluster provided by the embodiments of the present disclosure realizes the objective that the new servers equipped with new services are added to the server cluster. The new servers are adopted to substitute the original servers in the server cluster to receive the access requests, such that the server cluster can process the access requests of the user even in a service updating process, and the user experience is improved. In addition, in the service updating process of the server cluster, the user can experience the new service, and the launching speed of the new service is quickened. Further, the server cluster with the new services is tested online. When having a problem, the new servers can be debugged in time, such that the normal and effective operation of the new servers is guaranteed. Further, when the new servers are debugged, the working state of the original servers is recovered, such that the situation that the access requests cannot be processed caused by a fault of the new servers in the service updating process of the server cluster is avoided. The access requests sent to the original servers in the server cluster are indirectly sent to the new servers. Compared with a manner that the access requests received by the original servers in a substituting state are forwarded to other original servers, the work load of other substituting servers in the service updating process of the server cluster is reduced, and the work of scheduling the access requests is also simplified. The new servers gradually substitute the original servers in the server cluster to receive the access requests received by the original servers, such that the risk generated by a fact that the new servers directly substitute the original servers in the server cluster to receive the access requests received by the original servers is reduced.

As a further optimization of the method of the embodiment as shown in FIG. 1, the using by a service updating apparatus new servers to substitute part of the original servers to receive access requests includes:

closing by the service updating apparatus ports of the original servers for receiving the access requests, and configuring the same ports for receiving the access requests for the new servers.

The service updating apparatus is disposed with the ports to accept or refuse the access requests, and the configuration is convenient and simple, such that the aim that the access requests accepted by the original servers are accepted by the new servers indirectly is realized.

As an optimal embodiment of the method of the embodiment as shown in FIG. 1, the preset threshold value is determined based on the performance representation value of the original servers.

The service updating apparatus takes the performance representation value of the original servers as a reference point to evaluate the preset threshold value of working performances of the new servers, thereby ensuring that the working performances of the new servers are superior to those of the original servers.

As an optimal embodiment of the method of the embodiment as shown in FIG. 1, the performance representation value is determined based on a query per second and a response speed of the new server.

More particularly, the service updating apparatus obtains a query per second of the new server and a response speed of the access requests by calling a system log file of the new server.

The service updating apparatus judges whether the function of the new servers is adequate enough using the query per second, and judges whether an operation state of the new servers is stable using the response speed, thereby ensuring that the new sever can normally and effectively work and operate.

As an optimal embodiment of the method of the embodiment as shown in FIG. 1, the original servers are PHP system servers, and the new servers are JAVA system servers.

The PHP system operates based on a CGI or FastCGI technology, and the PHP system server is unsuitable for multi-core parallel processing. While the Java system server is realized based on a servlet technology and suitable for multi-core parallel processing. The Java server has better operation state in a distributed structure, such that the Java system is more favored by large-scale Internet companies that more users access.

Thus it can be seen that when huge concurrent access requests are processed, the Java system server has a higher handling capacity and a more stable operation state than the PHP system server.

More particularly, under the testing pressure of the huge concurrent access requests, when handling the access requests of the same large quantity, a query per second (QPS) of the Java system server is 5 times more than that of the PHP system server.

The method of the preferred embodiment is more specifically executed as follows.

The server cluster has a plurality of servers divided based on the difference of network types of the handled access requests, for example, a Telecom server, and a Unicom server; and in the present preferable embodiment, the original servers in the server cluster are PHP system servers, and the new servers are the Java system servers.

The Java system servers are added to the PHP system server cluster.

Telecom access requests are allocated to the nginx cluster by DNS intelligent parsing, the nginx cluster allocates the received access requests to each server suitable for receiving the access requests on average, and each server contains a Telecom server and a Java system server suitable for processing the Telecom access requests.

Whether all indexes of the Java system severs are normal is judged.

If a judging result is yes, the Telecom PHP system servers are removed from the serve cluster, and only the Java system servers are remained to process the requests, thereby finishing the service updating of the server cluster specific to the Unicom cluster access requests.

The access requests of all network types received by the server cluster are all distributed to a nginx cluster on average, and the service updating of the server cluster is finished with the same method.

More preferably, the nginx cluster is set to only receive the URI access requests of specific type.

As a preferable embodiment of the method of the embodiment as shown in FIG. 1, the access requests are access requests of preset URL types.

More particularly, in one case, the server cluster receives the access requests of a GPC (get player config) type; and in actual operation, the access requests are screened using the nginx cluster, and the screened access requests of the GPC type are sent to the server cluster.

Therefore, the new servers only receive and process the access requests of specific URL type, and the updating risk of the server cluster is reduced compared with a manner that the new servers receive and process the access requests of all URL types. In one case, a server operator updates the generated new servers specific to the access requests of the specific URL type, such that the access to the access requests of other URL types of the server cluster is not influenced by the new servers, and the access requests can still be processed by the original servers in the server cluster.

As a preferable embodiment of the method of the embodiment as shown in FIG. 1, the server cluster is a plurality of server clusters divided based on the difference of IP sections of the processed access requests and disposed on a server platform.

More particularly, different server clusters correspond to the IP sections of different regions, and the IP corresponding to the access requests are obtained by DNS parsing specific to the access requests.

Therefore, the gray level updating of the service of the server platform is realized.

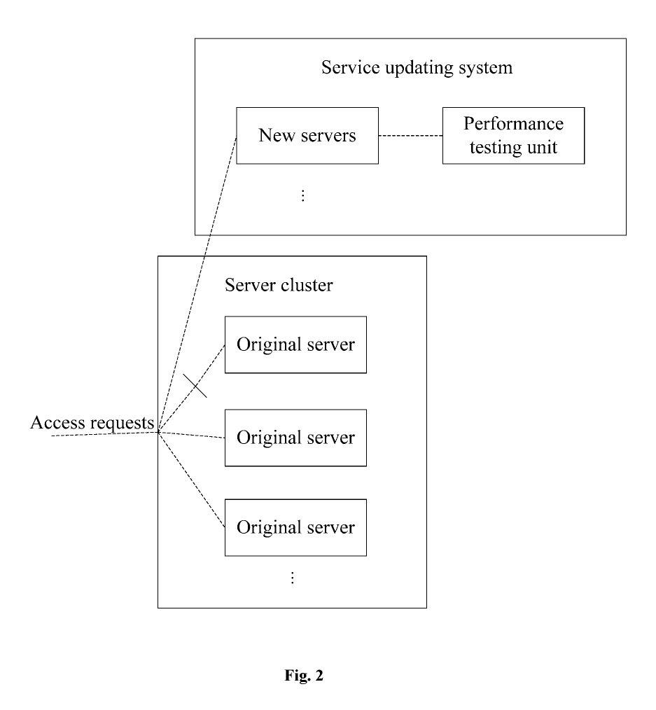

FIG. 2 shows a service updating system for a server cluster of an embodiment of the present disclosure, wherein the server cluster has a plurality of original servers, and the system includes new servers and a performance testing unit interacting with the new servers, and wherein,

the new servers are configured to perform local updating by substituting part of the original servers to receive access requests and execute a corresponding operation based on a signal sent from the performance testing unit;

the performance testing unit is configured to compare a performance representation value of the new servers with a preset threshold value; send a local updating canceling signal to the new servers if the performance representation value is lower than the preset threshold value; and send a local updating continuing signal to the new servers if the performance representation value is higher than the preset threshold value.

The performance testing unit may be a performance tester that may have at least one processor and a memory that is communicably connected with the at least one processor for storing instructions executable by the at least one processor. The execution of the instructions by the at least one processor may cause the at least one processor of the performance tester to conduct the performance test.

In the present embodiment, the service updating system for the server cluster may be a single server or a server cluster, the performance testing units may be a single server or a server cluster, and the new servers may be a single server or a server cluster. At this point, interaction between the performance testing unit and the new servers is represented as the interaction between the servers or server clusters. The service updating system for a server cluster provided by the embodiments of the present disclosure realizes the objective that the new servers equipped with new services are added to the server cluster. The new servers are adopted to substitute the original servers in the server cluster to receive the access requests, such that the server cluster can process the access requests of the user even in a service updating process, and the user experience is improved. In addition, in the service updating process of the server cluster, the user can experience the new service, and the launching speed of the new service is quickened. Further, the server cluster with the new service is tested online. When having a problem, the new servers can be debugged in time, such that the normal and effective operation of the new servers is guaranteed. Further, when the new servers is debugged, the working state of the original servers is recovered, such that the situation that the access requests cannot be processed caused by a fault of the new servers in the service updating process of the server cluster is avoided. The access requests sent to the original servers in the server cluster are indirectly sent to the new servers. Compared with a manner that the access requests received by the original servers in a substituting state are forwarded to other original servers, the work load of other substituting servers in the service updating process of the server cluster is reduced, and the work of scheduling the access requests is also simplified. The new servers gradually substitute the original servers in the server cluster to receive the access requests received by the original servers, such that the risk generated by a fact that the new servers directly substitute the original servers in the server cluster to receive the access requests received by the original servers is reduced.

As a further optimization of the system of the embodiment as shown in FIG. 2, the new servers are provided with a plurality of ports, which are the same as those of the original servers and are configured to receive the access requests.

Therefore, the access requests are accepted or refused by disposing the new servers and the ports of the original servers, and the configuration is convenient and simple, such that the aim that the access requests accepted by the original servers are accepted by the new servers indirectly is realized.

As further optimization of the system of the embodiment as shown in FIG. 2, the performance testing unit is disposed on a Linux virtual server (LVS) server.

More particularly, after the new servers with the new service are added to the serve cluster, an alarm item and an alarm threshold value can be registered to a zabbix platform of the LVS server cluster dynamically. A system log file of the new servers can be regularly called, a query per second of the new servers and a response speed of the access requests can be obtained, and working performance indexes can be determined. When the working performance indexes of the new servers exceed the threshold value, alarming is performed, thereby ensuring that the new servers can normally work and operate effectively.

As further optimization of the system of the embodiment as shown in FIG. 2, the server cluster is a plurality of server clusters divided based on the difference of IP sections of the processed access requests and disposed on a server platform.

More particularly, different server clusters correspond to the IP sections of different regions, and the IP corresponding to the access requests are obtained by DNS parsing specific to the access requests.

Therefore, the gray level updating of the service of the server platform is realized.

As further optimization of the system of the embodiment as shown in FIG. 2, the performance representation value is determined based on a query per second and response speed of the new servers.

Whether the functionality of the new servers is adequate enough is judged using the query per second, and whether an operation state of the new servers is stable is judged using the response speed, thereby ensuring that the new sever can work and operate normally and effectively.

As further optimization of the system of the embodiment as shown in FIG. 2, the original servers are PHP system servers, and the new servers are JAVA system servers.

When huge concurrent access requests are processed, the Java system servers have a higher handling capacity and a more stable operation state than the PHP system server.

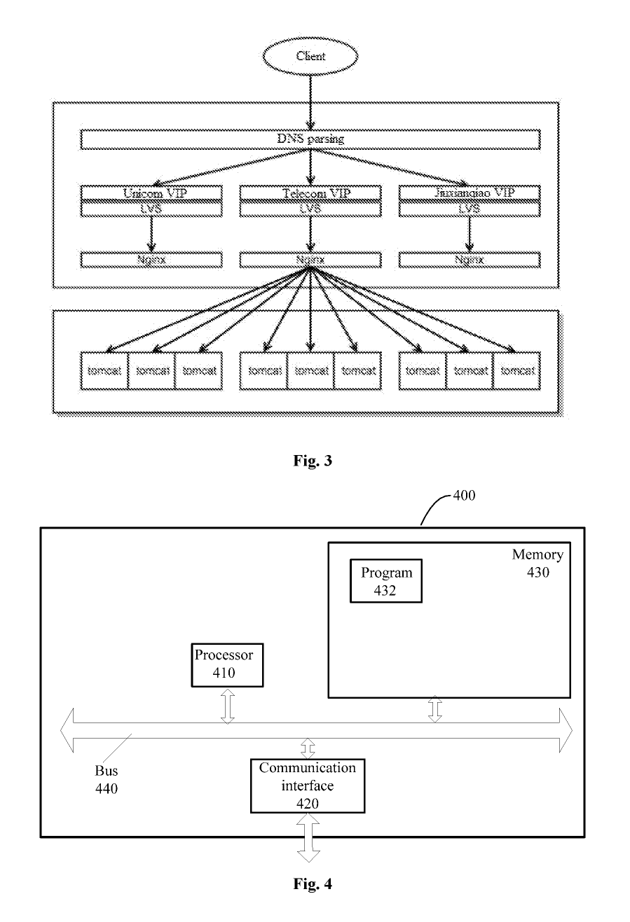

FIG. 3 shows a schematic drawing in which part of servers in a server cluster are updated according to an embodiment the present disclosure. The server cluster has a plurality of servers divided based on the difference of network types and regions of the processed access requests, for example, a Telecom server, a Unicom server and a Jiuxianqiao server; the Telecom server and the Unicom server are a Telecom server and a Unicom server to be updated in a region of Jiuxianqiao; and the Jiuxianqiao server is other servers to be updated rather than the Telecom server and the Unicom server in the region of Jiuxianqiao. In the specific embodiment, the new servers in the server cluster are tomcats, wherein the tomcats refer to a JAVA systems server, part of servers refer to the Telecom server, the tomcats are provided with ports for receiving access requests, and the ports for receiving the access requests on the Telecom sever are closed; therefore, the tomcats substitute the Telecom server to receive the Telecom access requests sent from a nginx server so as to perform local updating, and corresponding operation are executed based on signals sent from the performance testing unit disposed on the LVS server.

The performance testing unit is configured to compare a performance representation value of the new servers with a preset threshold value, and send a local updating canceling signal to tomcats if the performance representation value is lower than the preset threshold value. Based on the local updating canceling signal, tomcats close the ports for receiving the access requests to refuse to receive and process the access requests.

If the performance representation value of the Telecom server is higher than the preset threshold value, the tomcats process the Telecom access requests, and finish the service updating of the Telecom servers of the server cluster. Further, the service of the Unicom server receiving and processing the Unicom access requests sent from the nginx server is updated. The performance comparing unit compares the performance representation value of the Unicom server with the preset threshold value, and if the performance representation value of the Unicom server is lower than the preset threshold value, the ports of the tomcats for receiving the access requests are closed. If the performance representation value of the Unicom server is higher than the preset threshold value, the tomcats process the Unicom access requests. The Jiuxianqiao server is updated with the method of updating the Unicom server, and the service updating of the server cluster is finished when the services of the Telecom server, the Unicorn server and the Jiuxianqiao server are all updated.

In the embodiment of the present disclosure, related functional modules and units may be implemented by a hardware processor.

The embodiments of the present disclosure further provide a computer-readable non-transitory storage medium, the storage medium stores one or more programs including an executing instruction, and the executing instruction may be read and executed by an electronic device so as to execute the related steps in the above method embodiments. The method includes the following steps, for example:

performing local updating: using new servers to substitute part of the original servers to receive access requests;

performing performance testing: comparing a performance representation value of the new servers with a preset threshold value;

canceling the local updating if the performance representation value is lower than the preset threshold value, debugging the new servers, re-performing the debugged server with the local updating and performance testing till the performance representation value is higher than the preset threshold value; and

continuing to perform the local updating and the performance testing if the performance representation value is higher than the preset threshold value till the new servers substitute all the original servers to receive the access requests, thus finishing the service updating of the server cluster.

The embodiments of the present disclosure further provide an electronic device (including but not limited to a personal computer, a server, or a network device, etc.). FIG. 4 shows a structural schematic drawing of an embodiment of the electronic device 400. The specific embodiments of the present disclosure do not limit specific implementation manners of the electronic device 400. The electronic device 400 may include:

a processor 410, a communication interface 420, a memory 430 and a communication bus 440, wherein

the processor 401, the communication interface 420 and the memory 430 communicate with one another via the communication bus 440.

The communication interface 420 is used for communicating with a network element such as a client.

The processor 410 is configured to execute a program 432 in the memory 430 and specifically execute the related steps in the method embodiment.

Specifically, the program 432 may include a program code, including a computer operation instruction.

The processor 410 may be a central processing unit (CPU), or an application specific integrated circuit (ASIC), or configured to be one or more integrated circuits executing the embodiments of the present application.

The device in the above embodiment includes:

a memory, configured to store the computer operation instruction; and

a processor, configured to execute the computer operation instruction stored by the memory, to execute the operations of:

performing local updating: using new servers to substitute part of the original servers to receive access requests;

performing performance testing: comparing a performance representation value of the new servers with a preset threshold value;

canceling the local updating if the performance representation value is lower than the preset threshold value, debugging the new servers, re-performing the debugged server with the local updating and performance testing till the performance representation value is higher than the preset threshold value; and

continuing to perform the local updating and the performance testing if the performance representation value is higher than the preset threshold value till the new servers substitute all the original servers to receive the access requests, thus finishing the service updating of the server cluster.

The present disclosure further provides a non-transitory computer-readable storage medium storing executable instructions for updating a service for a server cluster including a plurality of original servers, wherein the executable instructions, when executed by a processor, cause the processor to: perform local updating by: using new servers to substitute part of the original servers to receive access requests; and perform performance testing by: comparing a performance representation value of the new servers with a preset threshold value; canceling the local updating if the performance representation value is lower than the preset threshold value, debugging the new servers, and re-performing the debugged server with the local updating and performance testing till the performance representation value is higher than the preset threshold value, and continuing to perform the local updating and the performance testing if the performance representation value is higher than the preset threshold value till the new servers substitute all the original servers to receive the access requests, thus finishing the service updating of the server cluster.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A service updating method of a server cluster comprising a plurality of original servers, the method comprising:
performing local updating by: using new servers to substitute part of the original servers to receive access requests; and
performing performance testing by: comparing a performance representation value of the new servers with a preset threshold value: canceling the local updating if the performance representation value is lower than the preset threshold value, debugging the new servers, and re-performing the debugged server with the local updating and performance testing till the performance representation value is higher than the preset threshold value; and continuing to perform the local updating and the performance testing if the performance representation value is higher than the preset threshold value till the new servers substitute all the original servers to receive the access requests, thus finishing the service updating of the server cluster.

2. The method according to claim 1, wherein using new servers to substitute part of the original servers to receive access requests comprises:
closing ports of the original servers for receiving the access requests, and configuring the same ports for receiving the access requests for the new servers.

3. The method according to claim 1, wherein the original servers are PHP system servers, and the new servers are JAVA system servers.

4. The method according to claim 1, wherein the preset threshold value is determined based on the performance representation value of the original servers.

5. The method according to claim 1, wherein the performance representation value is determined based on a query per second and a response speed of the new server.

6. A service updating system for a server cluster having a plurality of original servers, the system comprising new servers and a performance tester interacting with the new servers, wherein:
the new servers are configured perform local updating by substituting part of the original servers to receive access requests and execute a corresponding operation based on a signal sent from the performance tester; and
the performance tester is configured to compare a performance representation value of the new servers with a preset threshold value, send a local updating canceling signal to the new servers if the performance representation value is lower than the preset threshold value, and send a local updating continuing signal to the new servers if the performance representation value is higher than the preset threshold value.

7. The system according to claim 6, wherein the new servers are provided with a plurality of ports, which are the same as those of the original servers, and are configured to receive the access requests.

8. The system according to claim 6, wherein the original servers are PHP system servers, and the new servers are JAVA system servers.

9. The system according to claim 6, wherein the performance tester is disposed in an LSV server.

10. The system according to claim 6, wherein the performance representation value is determined based on a query per second and a response speed of the new server.

11. A non-transitory computer-readable storage medium storing executable instructions for updating a service for a server cluster comprising a plurality of original servers, wherein the executable instructions, when executed by a processor, cause the processor to:
perform local updating by: using new servers to substitute part of the original servers to receive access requests; and
perform performance testing by: comparing a performance representation value of the new servers with a preset threshold value; canceling the local updating if the performance representation value is lower than the preset threshold value, debugging the new servers, and re-performing the debugged server with the local updating and performance testing till the performance representation value is higher than the preset threshold value; and continuing to perform the local updating and the performance testing if the performance representation value is higher than the preset threshold value till the new servers substitute all the original servers to receive the access requests, thus finishing the service updating of the server cluster.

12. The non-transitory computer-readable storage medium according to claim 11, wherein the executable instructions, when executed by the processor, cause the processor to perform the local updating by using the new servers to substitute the part of the original servers to receive the access requests, further cause the processor to perform the local updating by:
closing ports of the original servers for receiving the access requests, and configuring the same ports for receiving the access requests for the new servers.

13. The non-transitory computer-readable storage medium according to claim 11, wherein the original servers are PHP system servers, and the new servers are JAVA system servers.

14. The non-transitory computer-readable storage medium according to claim 11, wherein the preset threshold value is determined based on the performance representation value of the original servers.

15. The non-transitory computer-readable storage medium according to claim 11, wherein the performance representation value is determined based on a query per second and a response speed of the new server.
